(19) United States
(12) Patent Application Publication
(10) Pub. No.: US 2009/0127130 A1
(43) Pub. Date: May 21, 2009

(54) Composite Membranes for Electrochemical Cells

(76) Inventors: Donald James Highgate, Surrey (GB); Simon Bourne, Sheffield (GB); Rachel Louise Smith, Sheffield (GB)

Correspondence Address: SALIWANCHIK LLOYD & SALIWANCHIK;A PROFESSIONAL ASSOCIATION, PO Box 142950, GAINESVILLE, FL, 32614, US

(21) Appl. No.: 12/282,685

(22) PCT Filed: Mar. 16, 2007
(86) PCT No.: PCT/GB07/00949

§ 371 Date: Oct. 29, 2008

(30) Foreign Application Priority Data
Mar. 16, 2006 (GB) 0605393.8

(51) Int. Cl. C25B 13/00; C25B 1/10; H01M 8/02

(52) U.S. Cl. 205/628; 204/282

(57) ABSTRACT

A membrane electrode assembly in which at least one water content, conductivity, pH, mechanical strength and elasticity of the membrane is graduated across its thickness, between the electrodes.

### FIELD OF THE INVENTION

This invention relates to an electrochemical cell and, in particular, to a membrane electrode catalyst assembly containing a membrane with differential properties.

### BACKGROUND OF THE INVENTION

Ionic polymer membranes used in electrochemical cells typically are an electrolyte comprising only one active material, having homogeneous properties throughout. WO2005/124893 discloses a composite membrane system.

### SUMMARY OF THE INVENTION

The present invention is based in part on an appreciation that, if the anode and cathode catalysts work in the same environment, this may be optimal for one, but detrimental to the activity of the other. This invention provides a means whereby the physical and chemical properties across a membrane of an MEA (membrane electrode assembly) can be controlled so that catalysis may be optimised. For example, a composite membrane system of the general type disclosed in WO2005/124893 can be adapted to provide different chemical properties at the electrode regions in an electrochemical cell, offering a route to improved performance. Additionally, the ability to alter the physical properties of the separate components of a composite membrane system offers a method of controlling processes in the electrochemical cell that have an impact on the performance of the cell.

According to the invention, a composite membrane comprises materials in which one or more selected properties, e.g. water content or conductivity, are controlled so as to be different at the anode and cathode. The membrane may comprise a plurality of materials that are inherently cationic and/or anionic, and optionally also hydrophilic.

Graduated (or varying) properties may be, but are not limited to, water content, conductivity, pH, mechanical strength and elasticity. Properties may be graduated in ratios of 1:1 to 20:1 across the membrane. Graduation may be stepped or continuous.

Advantages of using such a composite membrane may be improved water management, reduced cross-over of water and dissolved gases, improved mechanical properties, and providing the ability to optimise conditions for catalysis at the anode and the cathode.

### DESCRIPTION OF PREFERRED EMBODIMENTS

The MEA may comprise a single membrane with graduated properties. Alternatively, the MEA may comprise a plurality of homogeneous membranes which, when sandwiched together, form a membrane of graduated properties. A further alternative is that the MEA comprises homogeneous and graduated membranes.

One embodiment of a composite membrane is an electrolyser which incorporates an ionically active material having varying pH. A composite may comprise an inherently acidic membrane and an inherently basic membrane, the anode having the acidic and the cathode the basic environment. Such systems lend themselves to the use of Pt or alloys of Pt at the anode and Ni or alloys of Ni at the cathode.

A further embodiment of a composite membrane is an electrolyser which incorporates an tonically active material of varying water content. A composite may comprise an inherently acidic membrane of high water content and an inherently acidic membrane with low water content, the anode having the higher water content. Such systems improve water management and reduce cross-over of gases.

A preferred embodiment of such a system is a MEA catalyst structure comprising a cationic and anionic composite, providing the anode and cathode respectively. Such a composite may be produced by pressing two homogeneous membranes together to form a stepped transition between anionic and cationic materials. In a specific example, the anode may be catalysed by Pt, while the cathode is catalysed by Ni—Cr (70:30).

Another preferred embodiment is a MEA catalyst structure comprising a cationic membrane with graduated water content (between 1:1 and 1:20). The cathode may have the lower water content and a Ni—Cr (70:30) catalyst, while the anode has the higher water content and Pt catalysts.

As indicated above, a Pt electrode is preferred at that side of the MEA at which oxygen may be present. The metal on the other side is preferably nickel or nickel alloy such as nickel-chrome, but other suitable metals will be apparent to one of ordinary skill in the art.

The cell may be operated as an electrolyser or as a fuel cell. Examples of structures and fuels are given in WO03/023890 and WO2005/124893. The content of each of these specifications is incorporated herein by reference.

The following Example illustrates the invention. In the Example, an electrolyser comprises an ion-exchange membrane of differential water content through its thickness.

### Example

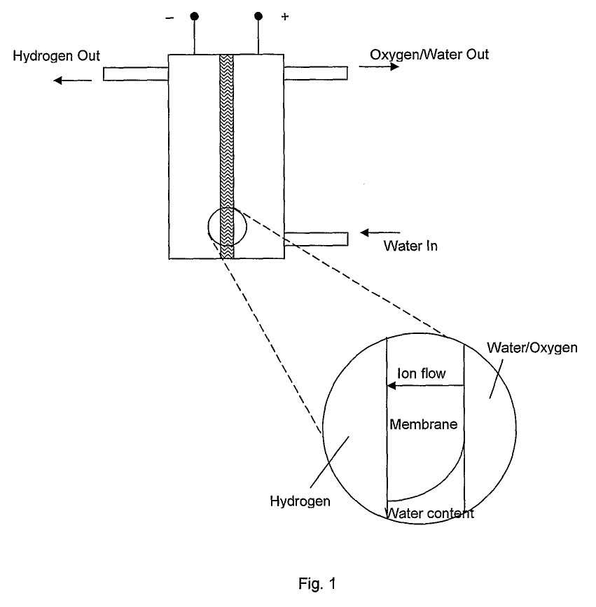

An electrolyser containing a cation exchange membrane was constructed as shown in FIG. 1. The anode was Pt coated Ti expanded mesh and the cathode was a NiCr expanded mesh.

The properties of the ion exchange membrane were such that the oxygen side exhibited a higher water content than the hydrogen side (e.g. 60% down to 30%). The materials were AN, VP, AMPSA, Water, Allyl methacralate. The ratio of AN:VP at the anode was different to that at the cathode, rendering a difference in hydrophilicity.

Water was supplied to the oxygen evolution side of the cell (positive). Water was not supplied to the hydrogen evolution side of the cell (negative).

The cell was operated with no obvious detriment to performance. No evidence of deterioration was observed as a result of the test programme. A stable cell voltage of about 4.7 v was observed over 3 hours.

Several advantages are associated with such a cell. Those include improved water access to the oxygen catalyst, by increased rate of water transport through the membrane local to the catalyst. This can make better use of the catalyst otherwise ‘blinded’ by contact with a conventional ‘low water content’ membrane, in turn enabling higher current density operation, alternative electrode design and alternative catalyst application/distribution options. In addition, reduced electro-osmotic drag and balance of plant can be achieved, by the modification of the tortuosity of water movement through the membrane. The complex/expensive balance of plant required to service the hydrogen side of the electrolyser with water, and to separate product gas from circulating water, can be avoided.

Further, the rapid removal of product hydrogen through the catalyst/electrode structure is provided, enabling alternative catalyst/electrode designs and methods of introduction to the membrane, and reducing mass transport as a performance limiting factor at high current densities/gas production rates. The environment on the hydrogen side of the electrolyser is predominantly free of water in liquid form. This favours the execution of additional chemical reactions that might otherwise necessitate one or more additional reaction vessels. Example reactions include the synthesis of hydrocarbons and alcohols using electrolytic hydrogen and carbon dioxide, and the synthesis of ammonia from electrolytic hydrogen and nitrogen.

1. A membrane electrode assembly in which at least one property of the membrane is graduated across its thickness, between the electrodes.

2. The assembly according to claim 1, wherein the at least one property comprises water content.

3. The assembly according to claim 1, wherein the at least one property comprises conductivity.

4. The assembly according to claim 1, wherein the at least one property comprises pH.

5. The assembly according to claim 1, wherein the at least one property comprises water mechanical strength and/or elasticity.

6. The assembly according to claim 1, wherein the at least one property varies by up to 20 fold.

7. A method of electrolysis in which a material provided on one side of a membrane electrode assembly is electrolysed, wherein the assembly is one in which at least one property of the membrane is graduated across its thickness, between the electrodes.

8. The method according to claim 7, wherein the material is water.

9. The method according to claim 8, wherein the environment on the hydrogen side of the assembly is predominantly free of water in liquid form.

10. The method according to claim 7, wherein the at least one property comprises water content.

11. The method according to claim 7, wherein the at least one property comprises conductivity.

12. The method according to claim 7, wherein the at least one property comprises pH.

13. The method according to claim 7, wherein the at least one property comprises water mechanical strength and/or elasticity.

14. The method according to claim 7, wherein the at least one property varies by up to 20 fold.
